(19) United States
(12) Patent Application Publication
(10) Pub. No.: US 2015/0210035 A1
(43) Pub. Date: Jul. 30, 2015

(54) SANDWICH COMPOSITE ELEMENT HAVING IMPROVED MECHANICAL PROPERTIES AND METHOD FOR PRODUCTION

(71) Applicant: Bayer MaterialScience AG, Monheim Am Rhein (DE)

(72) Inventors: Marc Rippel, Leverkusen (DE); Rolf Roers, Odenthal (DE); Catherine Lövenich, Bergisch Gladbach (DE); Walter Schindler, Burscheid (DE); Michael Büchele, Buttenwiesen (DE); Lars Pfeiffer, Mainz (DE)

(73) Assignee: Bayer MaterialScience AG, Monheim Am Rhein (DE)

(21) Appl. No.: 14/423,447

(22) PCT Filed: Aug. 23, 2013
(86) PCT No.: PCT/EP2013/067573

§ 371 Date: Feb. 24, 2015

(30) Foreign Application Priority Data
Aug. 27, 2012 (EP) 12181836.3

(51) Int. Cl. B32B 5/20; B32B 15/14; B32B 5/02; B32B 37/24; B32B 37/00

(52) U.S. Cl. CPC B32B 5/20; B32B 37/24; B32B 37/0038; B32B 5/026; B32B 15/14; B32B 2038/0084

(57) ABSTRACT

The invention relates to a sandwich composite element (100) and a method for producing a sandwich composite element (100) having a first outer layer (10) and a second outer layer (11), wherein a polyurethane foam core body (12) is arranged between the first outer layer (10) and the second outer layer (11). According to the invention, a subjacent outer layer (13, 14) for mechanically stiffening the composite element (100) is arranged between the foam core body (12) and at least one of the outer layers (10, 11).

The present invention pertains to a sandwich composite element with a first cover layer and a second cover layer, wherein a polyurethane foam core is arranged between the first cover layer and the second cover layer.

### PRIOR ART

EP 1 516 720 B1 discloses a method for manufacturing sandwich composite elements that feature a first cover layer and a second cover layer, as well as a polyurethane foam core arranged between the cover layers. The polyurethane foam core is produced by applying an expanding reaction mixture onto one of the cover layers. In order to improve the adhesion between the polyurethane foam core produced of the expanding reaction mixture and the cover layers, it is proposed to apply a polyurethane-based adhesion promoter onto the inner side of the cover layers. This adhesion promoter should have a density of 400-1200 kg/m3 and the thickness of the adhesion promoter layer should lie between 50 μm and 500 μm.

EP 2 412 526 A1 discloses another method for manufacturing sandwich composite elements with a structure that comprises two cover layers, between which a polyurethane foam core is situated. Options for placing adhesion promoter layers between the foam core and the cover layers are likewise proposed in this publication in order to improve the adhesion between the cover layers and the foam core.

WO 2010/076118 A1 discloses a sandwich composite element that comprises two metallic cover layers and a polyurethane foam layer arranged in between, as well as a compact polyurethane layer that contains microcapsules with a capsule core of latent heat storage material. This is intended to improve the thermal properties of the sandwich composite element.

Sandwich composite elements can basically serve as thermal insulation for buildings without being subjected to significant loads. In newer structures such as, for example, industrial buildings, the sandwich composite elements used actually form the wall elements of the building. Consequently, the sandwich composite elements must be able to withstand greater mechanical loads, for example, in order to absorb wind pressure and wind suction forces. In order to realize these sandwich composite elements with sufficient load bearing capacity, however, they cannot be manufactured with an arbitrary thickness for constructive reasons and, in particular, due to the resulting economical disadvantages. Conventional sandwich composite elements have a thickness, for example, up to 25 cm, wherein it is attempted to make available sandwich composite elements for the construction of building walls that have a thickness, for example, of only 10 cm, but in which the excellent thermal insulating properties are preserved.

Sandwich composite elements for the construction of building walls can be accommodated between steel girders such that they may have a substantial clear length. Steel supports, between which the sandwich composite elements are inserted, cannot be spaced apart by arbitrary distances because only sandwich composite elements with a finite length can be used as specified in so-called span tables. Wind forces that may be applied to the sandwich composite elements cannot lead to an overload thereof, wherein snow loads and the own weight of the composite elements also need to be taken into consideration in determining the clear length. However, it is generally attempted to increase the distance between steel girders in order to thusly reduce the absolute quantity of required steel girders and therefore the frame density of the building. When using sandwich composite elements with a thickness of only about 10 cm, for example, it is known to bridge spans of approximately 4 m. However, it would be desirable to make available sandwich composite elements that have the same thickness, but make it possible to bridge greater spans.

### DISCLOSURE OF THE INVENTION

It is the objective of the present invention to disclose sandwich composite elements with improved mechanical properties, as well as a method for the manufacture thereof.

Based on a sandwich composite element according to the preamble of Claim 1 and based on a method for manufacturing a sandwich composite element according to the known characteristics of Claim 11, this objective is attained with the characteristics disclosed in the respective characterizing portions of these claims. Advantageous enhancements of the invention are disclosed in the dependent claims.

The invention includes the technical characteristic of arranging a subjacent layer between the foam core and at least one of the cover layers in order to mechanically stiffen the composite element.

The inventive arrangement of a subjacent layer on the inner side of at least one or even both cover layers of the sandwich composite element mechanically stiffens the composite element, in particular, in that the formation of creases and wrinkles is significantly delayed in the cover layer of the composite element, under which the subjacent layer is arranged, when a bending load is exerted upon the sandwich composite element. When the composite element is subjected to a bending load, for example, the subjacent layer may be provided underneath the cover layer that is arranged inside the bending curve. However, at least one subjacent layer may be respectively provided, in particular, under both cover layers.

According to a particularly advantageous embodiment of the invention, at least one subjacent layer, preferably both subjacent layers, may consist of polyurethane. The polyurethane foam core basically is very flexible in comparison with the material of the cover layers. If the cover layers are directly arranged on the polyurethane foam core, this results in only a marginal support effect for the cover layers due to a low bedding modulus with little bedding tension. However, if subjacent layers of polyurethane, which have a greater rigidity, hardness and, in particular, a higher modulus of elasticity than the polyurethane foam core, are arranged adjacent to the inner side of the cover layers of the composite element in accordance with the invention, a mechanical support effect for the cover layers is created because a higher bedding modulus is achieved. When the sandwich composite element is subjected to a mechanical load, for example, the formation of creases and wrinkles in the cover layer lying inside the bending line can therefore begin much later, i.e., under significantly higher loads. The formation of creases and wrinkles manifests itself, in particular, in an undulation of the cover layer lying inside a bend of the composite element such that the cover layer can quickly separate from the polyurethane foam core. This problem also cannot be solved with adhesion promoter layers that can indeed improve the adhesion between the cover layers and the foam core, but a mechanical support effect cannot be achieved with these very thin adhesion promoter layers. The higher bedding tension for the adjacent cover layer can only be achieved with the subjacent layers of polyurethane that have a higher rigidity than the foam core, wherein this higher bedding tension delays the formation of creases and wrinkles in the cover layers such that the mechanical load bearing capacity of the sandwich composite elements is improved.

Another advantage can be seen in that the number of fasteners required for mounting the composite elements can be reduced. Due to the increased load bearing capacity achieved by means of the subjacent layers, it is advantageously possible to use fewer fasteners to be inserted into the composite elements such as, for example, bolts, nails, pins or the like.

The at least one subjacent layer may also consist of polyurethane and at least partially comprise a glass fiber material, particularly knitted glass fiber fabrics. In this case, the glass fiber material and particularly the knitted glass fiber fabric may be impregnated, for example, with the polyurethane of the subjacent layer, wherein it would also be possible to provide subjacent layers that comprise a glass fiber material and are impregnated with a substance that contains no polyurethane.

In addition to increasing the mechanical strength of the composite elements, the invention furthermore utilizes the positive properties of a glass fiber mat for improving the fire protection characteristics of sandwich composite elements. The improved fire protection characteristics of the sandwich composite elements are achieved, in particular, in that the glass fiber mat is arranged on the inner side of either the first or the second cover layer. The reason can be seen in the melting characteristics of a glass fiber mat under the influence of heat, wherein these melting characteristics cause cross-linking of the fibrous glass material such that the material of the hard polyurethane foam core is shielded from the effect of direct flames because the viscous molten glass mass protects the hard foam core. It was determined, in particular, that the formation of cracks in the hard foam core is prevented or at least delayed such that a burn-through of a sandwich composite element with an inventive glass fiber mat incorporated therein is prevented or at least significantly delayed under continuous flame impingement.

The glass fiber material may be advantageously realized in the form of a knitted glass fiber fabric, wherein the term knitted fabrics or knitwear describes fabrics that are industrially produced of thread systems on a knitting machine and therefore categorized as knitted goods. In this context, one distinguishes between weft knitted goods and warp knitted goods. The knitted glass fiber fabric used as part of the subjacent layers may have a thickness that approximately corresponds to the thickness of the subjacent layers such that the knitwear may have a three-dimensional structure. The properties of the subjacent layers of polyurethane described below can presently also be advantageously utilized in combination with a glass fiber material.

It is particularly advantageous if the cover layers consist of a metal strip, particularly a steel strip or an aluminum strip. The first and the second cover layer of the composite element do not necessarily have to consist of the same material, wherein the first cover layer may be made of a first material and the second cover layer may be made of a second material that differs from the first material. For example, the sandwich composite element may feature a steel strip on one side and an aluminum strip on the opposite second side, wherein plastic materials may also be used for realizing the cover layers. These plastic materials may comprise, for example, glass fiber materials or carbon fiber materials, particularly fiber-reinforced plastics in general. The utilization of polyurethane in combination with glass fiber materials or carbon fiber materials represents a particularly advantageous material selection.

The subjacent layers of polyurethane may advantageously have a higher mass density than the polyurethane foam core. Due to the lower density of the polyurethane foam core, the sandwich composite element has a lower overall mass than a panel with higher mass density over its entire cross section. The mass densities of the subjacent layers of polyurethane may particularly differ from one another such that the polyurethane layers may have three different mass densities over the thickness of the entire sandwich composite element. In the following portion of the description, for example, the mass density of the subjacent layers of polyurethane is assumed to be identical and identified by the reference symbol ρ2.

For example, the polyurethane foam core 30 may have a mass density ρ1 between 30 kg/m3 and 60 kg/m3, preferably between 35 kg/m3 and 50 kg/m3, particularly about 40 kg/m3. The subjacent layers of polyurethane may have a mass density, for example, between 60 kg/m3 and 140 kg/m3, preferably between 80 kg/m3 and 120 kg/m3, particularly 100 kg/m3. Consequently, the subjacent layers of polyurethane may have a mass density ρ2 that is 1.5-times to 4-times higher, preferably 2-times to 3-times higher, particularly 2.5-times higher, than the mass density pρ1 of the polyurethane foam core.

If the subjacent layer is realized with a glass fiber material, the aforementioned different mass densities for the subjacent layer of polyurethane may be used, but it would also be conceivable that the material and, in particular, the mass density of the subjacent layers do not differ from those of the polyurethane foam core. In this case, the strengthening effect of the subjacent layer is achieved in that the three-dimensional glass fiber material with a corresponding thickness improves the mechanical properties while the polyurethane material remains otherwise unchanged. However, the mass densities of the subjacent layers, which may merely comprise an additional glass fiber material in this case, are preferably adapted in the above-described fashion.

According to another advantageous embodiment of the sandwich composite element, the subjacent layers of polyurethane may respectively have a thickness that corresponds to 3% to 20%, preferably 5% to 15%, particularly 10%, of the thickness of the sandwich composite element, wherein the thickness of the sandwich composite element has a value of 30 mm to 250 mm, preferably 80 mm to 120 mm, particularly 100 mm. According to an advantageous exemplary embodiment, the sandwich composite element may therefore have an overall thickness of 100 mm, wherein the polyurethane foam core has a thickness of 80 mm and the subjacent layers of polyurethane may respectively have a thickness of 10 mm, but the subjacent layers may also differ in thickness, and wherein the subjacent layers may also differ, in particular, with respect to their chemical or material properties. The thickness of the cover layers, which amounts, for example, to 0.2 to 5 mm depending on the design of the sandwich composite element, is neglected in this case.

According to another advantageous embodiment, the polyurethane foam core and the subjacent layers of polyurethane may be respectively produced of an expanding reaction mixture and consist at least of the combined mixture components isocyanate and polyol such that a rigid PUR and/or PIR foam body is produced. For example, the polyurethane foam core and the subjacent layers of polyurethane may have the same chemical composition, wherein different quantities of foaming agent are used for producing the layers of reaction mixtures. Consequently, the reaction mixture for producing the subjacent layers of polyurethane may be expanded with a smaller quantity of foaming agent than the reaction mixture for producing the polyurethane foam core. The higher the quantity of foaming agent added to the reaction mixture for its expansion, the lower the density of the produced foam body.

An adhesion promoter layer that may likewise be based on polyurethane can be applied underneath only one or underneath both subjacent layers in order to improve the adhesion of the cover layers on the subjacent layers of polyurethane. The adhesion promoter layers may be arranged between the cover layers and the subjacent layers that are applied onto the respective inner sides with suitable application methods, for example by means of a rotary table, in a continuous manufacturing process.

The polyurethane foam core and the subjacent layers of polyurethane may be respectively produced of an expanding reaction mixture and consist at least of the combined mixture components isocyanate and polyol such that a rigid PUR and/or PIR foam body is produced. In this case, the reaction mixture for producing the subjacent layers of polyurethane may be expanded with a smaller quantity of foaming agent than the reaction mixture for producing the polyurethane foam core.

The expanding reaction mixtures may be produced with at least the combined mixture components isocyanate and polyol, wherein the rigid polyurethane foam core comprises a rigid PUR or PIR foam material, and wherein flame retardants, especially bromic and chloric polyols or phosphor compounds such as esters of orthophosphoric acid and metaphosphoric acid, particularly containing halogen, may be added to the reaction mixture.

The expanding reaction mixtures may be produced at least of the components isocyanate and polyol. Hydrocarbons such as, for example, the isomers of pentane or fluorohydrocarbons, e.g. HFC 245fa (1,1,1,3,3-pentafluoropropane), HFC 365mfc (1,1,1,3,3-pentafluorobutane) or their mixtures with HFC 227ea (heptafluoropropane), may be used as the foaming agent added to the expanding reaction mixtures consisting of the isocyanate component and the polyol component. Different classes of foaming agents can also be combined. Water and/or formic acid or other organic carbonic acids may be used as secondary foaming agent added to the expanding reaction mixtures consisting of the isocyanate and polyol components.

Flame retardants may be added to the expanding PUR-PIR reaction mixtures, preferably in a quantity between 5 and 35 mass % referred to the overall mass of compounds with hydrogen atoms reactive to isocyanate groups in the polyol component. The flame retardants may consist, for example, of bromic and chloric polyols or phosphor compounds such as the esters of orthophosphoric acid and metaphosphoric acid, which may also contain halogen. It is preferred to choose flame retardants that are liquid at room temperature.

Catalysts may be added to the expanding reaction mixtures consisting of the isocyanate component and the polyol component. For example, these catalysts may consist of: triethyldiamine, N,N-dimethylcyclohexylamine, tetramethylenediamine, I-methyl-4-dimethylaminoethylpiperazine, triethylamine, tributylamine, dimethylbenzylamine, N,N′,N″-tris-(dimethylaminopropyl)hexahydrotriazine, dimethylaminopropyl formamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis-(dimethylaminopropyl)-carbamide N-methyl-morpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin-(II)-acetate, tin-(II)-octoate, tin-(II)-ethylhexoate, tin-(II)-laurate, dibutyltin diacetate, dibutyltin dilaurate, dibutyltin maleate, dioctyltin diacetate, tris-(N,N-dimethylaminopropyl)-s-hexahydrotriazine, tetramethyl ammonium hydroxide, sodium acetate, sodium octate, potassium acetate, potassium octate, sodium hydroxide or mixtures of these catalysts.

Foam stabilizers, preferably polyethersiloxanes, may furthermore be added to the expanding reaction mixtures consisting of the isocyanate and the polyol component. These compounds may be realized in such a way that a copolymer of ethylene oxide and propylene oxide is combined with a polydimethylsiloxane radical.

The addition of additives, catalysts and the like to the expanding reaction mixtures may be carried out before or during the mixing of the polyol and isocyanate components.

The present invention furthermore pertains to a method for manufacturing a sandwich composite element with a first cover layer and a second cover layer, wherein a polyurethane foam core is arranged between the first cover layer and the second cover layer, wherein the cover layers are continuously fed to a twin-belt transport system, and wherein the method features at least the following steps:
applying an expanding reaction mixture onto at least one of the cover layers in order to produce a strengthening subjacent layer, and
applying an expanding reaction mixture onto at least one subjacent layer or onto the inner side of one of the cover layers in order to produce the polyurethane foam core.

The method may be carried out in such a way that a subjacent layer, which may consist of polyurethane and additionally comprise, for example, a glass fiber material, is applied onto each of the cover layers. The explanations, characteristics and advantages of the above-described inventive composite element apply analogously to the presently described method.

The at least one reaction mixture may consist of the mixture components isocyanate and polyol that are preferably combined by means of a mixing head and produce a PUR and/or PIR foam. The reaction mixture may be applied, for example, with at least one spray head or with a stationary or oscillating pouring rake.

Separate mixing heads and pouring rakes or spray heads may be respectively assigned to the reaction mixtures for producing the subjacent layers of polyurethane in order to realize their separate application onto the inner sides of the cover layers, wherein a separate mixing head may likewise be assigned to the reaction mixture for the polyurethane foam core. In this case, the quantity of foaming agent added to the reaction mixture for producing the subjacent layers of polyurethane may be smaller than the quantity of foaming agent added to the reaction mixture for producing the polyurethane foam core. In this way, the resulting density of the polyurethane foam core is lower than that of the subjacent layers of polyurethane. The mixture components isocyanate and polyol may in this case be realized identically for the polyurethane foam core and for the subjacent layers of polyurethane and produce a PUR and/or a PIR foam.

According to another embodiment of the method for manufacturing a sandwich composite element, an adhesion promoter layer may be applied onto the at least one cover layer before the application of the expanding reaction mixture onto the first cover layer in order to produce the first subjacent layer of polyurethane and/or before the application of the expanding reaction mixture onto the second cover layer in order to produce a second subjacent layer of polyurethane.

### PREFERRED EXEMPLARY EMBODIMENT OF THE INVENTION

Other measures that enhance the invention are elucidated below in connection with the description of a preferred exemplary embodiment of the invention with reference to the figures. In these figures:

FIG. 1 shows an exemplary embodiment of an inventive sandwich composite element,

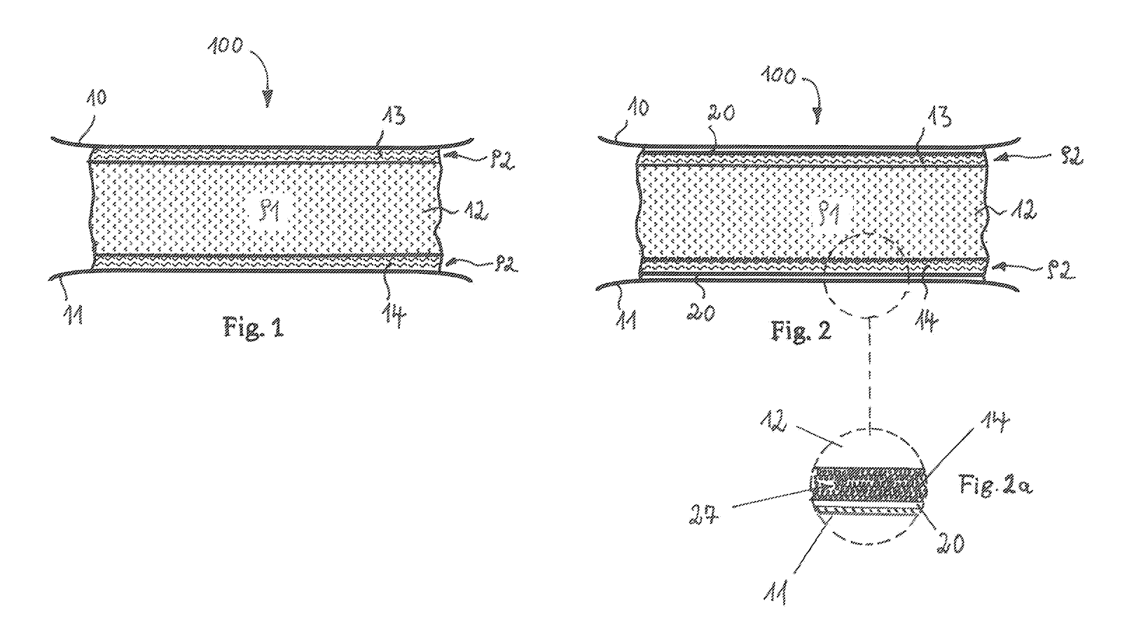

FIG. 2 shows the exemplary embodiment of the sandwich composite element according to FIG. 1, wherein an adhesion promoter layer is respectively illustrated between the cover layers and the subjacent layers of polyurethane,

FIG. 2a shows an enlarged detail of FIG. 2, and

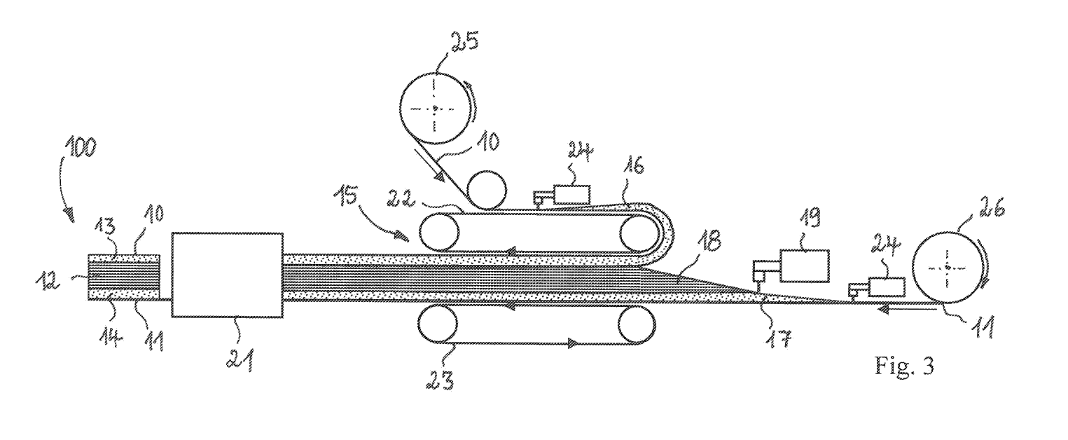

FIG. 3 shows a schematic illustration of an exemplary embodiment of a device for manufacturing sandwich composite elements with the characteristics of the present invention.

FIG. 1 shows a sandwich composite element 100 with a first cover layer 10 and a second cover layer 11, wherein the first cover layer 10 is illustrated in the form of an upper cover layer and the second cover layer 11 is illustrated in the form of a lower cover layer. A polyurethane foam core 12 is arranged between the upper cover layer and the lower cover layer. As an example, a subjacent layer 13, 14 is provided under both cover layers 10 and 11, wherein a subjacent layer 13 or 14 may also be provided under only one of the cover layers 10 or 11. The subjacent layers 13 and 14 are realized, for example, in the form of polyurethane layers with the above-described properties. Consequently, a first subjacent layer 13 of polyurethane is arranged between the foam core 12 and the upper, first cover layer 10 and another subjacent layer 14 of polyurethane is arranged between the foam core 12 and the lower, second cover layer 11 in order to mechanically stiffen the composite element 100 on both sides, wherein the subjacent layers 13 and 14 of polyurethane are illustrated without glass fiber material. The subjacent layers 13 and 14 have a mass density ρ2 whereas the polyurethane foam core 12 has a mass density ρ1. The mass density ρ1 of the foam core 12 amounts, for example, to 40 kg/m3 and the mass density ρ2 of the subjacent layers 13 and 14 of polyurethane amounts, for example, to 100 kg/m3 such that the mass density of the subjacent layers 13, 14 is 2.5-times greater than the mass density of the foam core 12. The exemplary embodiment of the sandwich composite element 100 shown has an overall thickness of 100 mm, wherein the thickness of the polyurethane foam core 12 amounts, for example, to 80 mm. Consequently, the subjacent layers 13 and 14 respectively have a thickness of 10 mm.

FIG. 2 shows the exemplary embodiment of the sandwich composite element 100 according to FIG. 1 with a first cover layer 10 and a second cover layer 11, wherein a polyurethane foam core 12 is arranged between the cover layers 10 and 11. Subjacent layers 13 and 14 of polyurethane are illustrated between the polyurethane foam core 12 and the cover layers 10 and 11, wherein ρ1 is once again the mass density of the polyurethane foam core 12 and ρ2 is the mass density of the subjacent layers 13 and 14 of polyurethane, and wherein these mass densities are, for example, realized identically, but may alternatively also differ.

A first adhesion promoter layer 20 is arranged between the subjacent layer 13 of polyurethane and the upper, first cover layer 10 and another adhesion promoter layer 20 is illustrated between the second subjacent layer 14 of polyurethane and the lower, second cover layer 11. These adhesion promoter layers 20 improve the adhesion of the cover layers 10 and 11 on the subjacent layers 13 and 14.

FIG. 2a shows an enlarged detail of FIG. 2 in the region of the lower, second cover layer 11 and the subjacent layer 14 of polyurethane situated underneath the cover layer 11. In addition, the adhesion promoter layer 20 is illustrated in the form of a layer between the cover layer 11 and the subjacent layer 14 of polyurethane. The subjacent layer 14 of polyurethane comprises, for example, a knitted glass fiber fabric 27 that is impregnated with the polyurethane of the subjacent layer 14, wherein the illustration of this knitted glass fiber fabric is also representative for the subjacent layer 13 of polyurethane.

FIG. 3 shows a device for carrying out a method for manufacturing sandwich composite elements 100 according to the exemplary embodiment illustrated in FIG. 1. The method is carried out with a device that essentially consists of a twin-belt transport system 15. The twin-belt transport system 15 features an upper conveyor belt 22 and a lower conveyor belt 23, wherein the conveyor belts 22 and 23 respectively rotate with the same speed in the direction of the arrows shown. A gap extends between the conveyor belts 22 and 23 and a first cover layer 10 and a second cover layer 11 are drawn into this gap, wherein the upper, first cover layer 10 is guided along the upper conveyor belt 22 and the second cover layer 11 is guided along the lower conveyor belt 23.

The first cover layer 10 is unwound from a first cover layer reel 25 and the second cover layer 11 is unwound from a second cover layer reel 26 such that the cover layers 10 and 11, as well as the cover layer reels 25 and 26, move in the directions of the arrows shown during the operation of the twin-belt transport system 15.

An expanding reaction mixture 17 is applied onto the inner side of the second cover layer 11 with a first mixing head 24, wherein this reaction mixture subsequently expands and forms the subjacent layer 14 of polyurethane arranged on the inside of the second cover layer 11. A reaction mixture 18, which subsequently expands and forms the polyurethane foam core 12, is applied onto the still expanding or already expanded reaction mixture 17 with an additional mixing head 19. An expanding reaction mixture 16, which subsequently expands into the gap between the cover layers 10 and 11 and comes in contact with the expanding or already expanded reaction mixture 18, is applied onto the inner side of the first cover layer 10 with an additional mixing head 24. Consequently, the expanding reaction mixture 16 forms the subjacent layer 13 of polyurethane arranged on the underside of the first cover layer 10.

As an alternative to the application of the reaction mixture 16 onto the inner side of the upper cover layer 10, this reaction mixture may also be applied against the underside of the upper cover layer 10 by means of a spraying process in an overhead arrangement in order to subsequently feed the first cover layer 10 to the twin-belt transport system 15.

During or after the passage of the cover layers 10 and 11, as well as the foam core 12 and the subjacent layers 13 and 14 arranged in between these cover layers, the sandwich composite can be separated into individual sandwich composite elements 100 by means of a separating device 21. These sandwich composite elements then have a structure of the type illustrated in FIG. 1.

Although not illustrated in the figure, an adhesion promoter layer may be applied onto the second cover layer 11 before the application of the reaction mixture 17 onto the inner side of the second cover layer 11 by means of the mixing head 24, wherein another adhesion promoter layer may likewise be applied onto the inner side of the first cover layer 10 before the application of the reaction mixture 16 onto the inner side of the first cover layer 10 by means of the mixing head 24 in order to manufacture a sandwich composite element 100 according to the exemplary embodiment in FIG. 2 with the device shown.

The implementation of the invention is not limited to the preferred exemplary embodiment described above. In fact, numerous variations are conceivable which utilize the described solution, namely also in implementations of a fundamentally different type. All characteristics and/or advantages disclosed in the claims, the description or the drawings including constructive details or spatial arrangements may be essential to the invention individually, as well as in various combinations.

### LIST OF REFERENCE SYMBOLS

100 Sandwich composite element
10 First cover layer
11 Second cover layer
12 Polyurethane foam core
13 Subjacent layer of polyurethane
14 Subjacent layer of polyurethane
15 Twin-belt transport system
16 Reaction mixture
17 Reaction mixture
18 Reaction mixture
19 Mixing head
20 Adhesion promoter layer
21 Separating device
22 Upper conveyor belt
23 Lower conveyor belt
24 Mixing head
25 First cover layer reel
26 Second cover layer reel
27 Knitted glass fiber fabric
ρ1 Mass density of polyurethane foam core
ρ2 Mass density of subjacent layer of polyurethane

1-15. (canceled)

16. A sandwich composite element (100) with a first cover layer (10) and a second cover layer (11), wherein a polyurethane foam core (12) is arranged between the first cover layer (10) and the second cover layer (11),
characterized in that a subjacent layer (13, 14) is arranged between the foam core (12) and at least one of the cover layers (10, 11) in order to mechanically stiffen the composite element (100).

17. The sandwich composite element (100) according to claim 16, characterized in that at least one subjacent layer, preferably both subjacent layers (10, 11), consist of polyurethane and, in particular, at least partially comprise a glass fiber material, particularly a knitted glass fiber fabric (27).

18. The sandwich composite element (100) according to claim 16, characterized in that the first cover layer (10) and/or the second cover layer (11) consist of a metal strip, particularly a steel strip or an aluminum strip.

19. The sandwich composite element (100) according to claim 16, characterized in that the subjacent layers (13, 14) of polyurethane have a mass density (ρ2) that is higher than the mass density (ρ1) of the polyurethane foam core (12).

20. The sandwich composite element (100) according to claim 16, characterized in that the polyurethane foam core (12) has a mass density (ρ1) of 30 kg/m3 to 60 kg/m3, preferably 35 kg/m3 to 50 kg/m3, particularly 40 kg/m3, wherein the subjacent layers (13, 14) of polyurethane have a mass density (ρ2) of 60 kg/m3 to 140 kg/m3, preferably 80 kg/m3 to 120 kg/m3, particularly 100 kg/m3.

21. The sandwich composite element (100) according to claim 16, characterized in that the mass density (ρ2) of the subjacent layers (13, 14) of polyurethane amounts to 1.5-times to 4-times, preferably 2-times to 3-times, particularly 2.5-times, the mass density (ρ1) of the polyurethane foam core (12).

22. The sandwich composite element (100) according to claim 16, characterized in that the subjacent layers (13, 14) of polyurethane respectively have a thickness that corresponds to 3% to 20%, preferably 5% to 15%, particularly 10%, of the thickness of the sandwich composite element (100), wherein the thickness of the sandwich composite element (100) has a value of 30 mm to 250 mm, preferably 80 mm to 120 mm, particularly 100 mm.

23. The sandwich composite element (100) according to claim 16, characterized in that the polyurethane foam core (12) and the subjacent layers (13, 14) of polyurethane are respectively produced of an expanding reaction mixture (16, 17, 18) and consist, in particular, at least of the combined mixture components isocyanate and polyol such that a rigid PUR and/or PIR foam body is preferably produced.

24. The sandwich composite element (100) according to claim 23, characterized in that the reaction mixture (16, 17) for producing the subjacent layers (13, 14) of polyurethane are expanded with a smaller quantity of foaming agent than the reaction mixture (18) for producing the polyurethane foam core (12).

25. The sandwich composite element (100) according to claim 16, characterized in that an adhesion promoter layer (20) is arranged between the cover layers (10, 11) and the subjacent layers (13, 14) of polyurethane.

26. A method for manufacturing a sandwich composite element (100) with a first cover layer (10) and a second cover layer (11), wherein a polyurethane foam core (12) is arranged between the first cover layer (10) and the second cover layer (11), wherein the cover layers (10, 11) are continuously fed to a twin-belt transport system (15), and wherein the method features at least the following steps:
applying an expanding reaction mixture (16, 17) onto at least one cover layer (10, 11) in order to produce a strengthening subjacent layer (13, 14), and
applying an expanding reaction mixture (18) onto a subjacent layer (13, 14) or onto the inner side of one of the cover layers (10, 11) in order to produce the polyurethane foam core (12).

27. The method according to claim 26, characterized in that the at least one reaction mixture (16, 17, 18) is produced of the mixture components isocyanate and polyol that are preferably combined with a mixing head (19, 24) and produce a PUR and/or PIR foam.

28. The method according to claim 26, characterized in that the quantity of foaming agent added to the reaction mixtures (16, 17) for producing the subjacent layers (13, 14) of polyurethane is smaller than the quantity of foaming agent added to the reaction mixture (18) for producing the polyurethane foam core (12).

29. The method according to claim 26, characterized in that an adhesion promoter layer (20) is applied onto the at least one cover layer (10, 11)
before the application of the expanding reaction mixture (16) onto the first cover layer (10) in order to produce the first subjacent layer (13) of polyurethane and/or
before the application of the expanding reaction mixture (17) onto the second cover layer (11) in order to produce the second subjacent layer (14) of polyurethane.

30. The method according to claim 26, characterized in that
a glass fiber material (27) is added to at least one of the subjacent layers (13, 14) or this layer consists of a glass fiber material (27).
